(19) United States
(12) Patent Application Publication
(10) Pub. No.: US 2024/0040008 A1
(43) Pub. Date: Feb. 1, 2024

(54) Hardware Pairing Communication for Streaming Service

(71) Applicant: Apple Inc., Cupertino, CA (US)

(72) Inventor: Madhusudan Rao, Dublin, CA (US)

(21) Appl. No.: 18/361,576

(22) Filed: Jul. 28, 2023

Related U.S. Application Data
(60) Provisional application No. 63/369,860, filed on Jul. 29, 2022.

(51) Int. Cl. H04L 67/51; H04L 9/40; G06F 21/73; G06F 21/82

(52) U.S. Cl. CPC H04L 67/51; H04L 63/0876; G06F 21/73; G06F 21/82

(57) ABSTRACT

Providing a service offer includes receiving, at a local device, a connection request to connect a hardware accessory with the local device, identifying, in response to the connection request, one or more services for the local device based on the hardware accessory, and presenting a prompt on a user interface to initiate access by the local device to the service. The services can be identified based on the hardware accessory device or a user account associated with the connection request.

### TECHNICAL FIELD

Embodiments described herein relate to providing access to services on an electronic device. More particularly, embodiments described herein relate to a technique for providing access to resources in association with a hardware connection event.

### BACKGROUND

In recent years, downloading of software applications (or “apps”) from an on-line distribution platform, such as an app store, has become a popular method for obtaining software applications. An on-line app store allows users to download a software application onto their device, such as a desktop computer or laptop computer, smartphone, or other mobile device, and then install the app on their device. In some instances, the access to the apps may be regulated, for example based on a user account, subscription, or the like.

### BRIEF DESCRIPTION OF THE DRAWINGS

Embodiments described herein are illustrated by examples and not limitations in the accompanying drawings, in which like references indicate similar features. Furthermore, in the drawings, some conventional details have been omitted, so as not to obscure the inventive concepts described herein.

FIG. 1 illustrates, in block diagram form, network by which apps are provided in an app store, according to one or more embodiments.

FIGS. 2A-2B illustrate example flow diagrams of example interfaces for accessing services in association with a hardware connection, in accordance with one or more embodiments.

FIG. 3 illustrates, in flowchart form, a technique for providing a service offer during a hardware connection event, in accordance with one or more embodiments.

FIG. 4 illustrates, in flowchart form, a technique for determining available service offers for a client device, in accordance with one or more embodiments.

FIG. 5 illustrates an example network diagram for providing access to resources in association with a hardware connection event, in accordance with one or more embodiments.

FIG. 6 illustrates an example flow diagram for selecting and providing offers to access to resources, in accordance with one or more embodiment.

FIG. 7 illustrates a simplified functional block diagram of an illustrative programmable electronic device, in accordance with an embodiment.

### DETAILED DESCRIPTION

This disclosure pertains to systems, methods, and computer readable media for providing an offer to a user to access enhancement services, such as digital services, in response to detecting a hardware connection event. In some embodiments, techniques described herein provide an improved technique for determining and providing enhancement service requests based on a newly connected hardware device.

Embodiments described herein are directed to a technique for facilitating a pairing or other connection event between a user device and an accessory hardware device. The accessory hardware device may include, for example, devices and systems communicably connected to the user device, for example by a wired or wireless connection, such as Bluetooth or other short range connection. For example, when a connection event is detected, then a determination can be made as to available enhancement service offers for the user and/or related to the hardware device. In some embodiments, the user device may present the offer for the enhancement service from within a connection interface related to the accessory hardware device. In some embodiments, the offered enhancement services may be useful in association with the connected hardware accessory, but are not necessary for the operation of the hardware accessory. Further, the offered enhancement services may be provided by the same or different entities as the hardware accessory device.

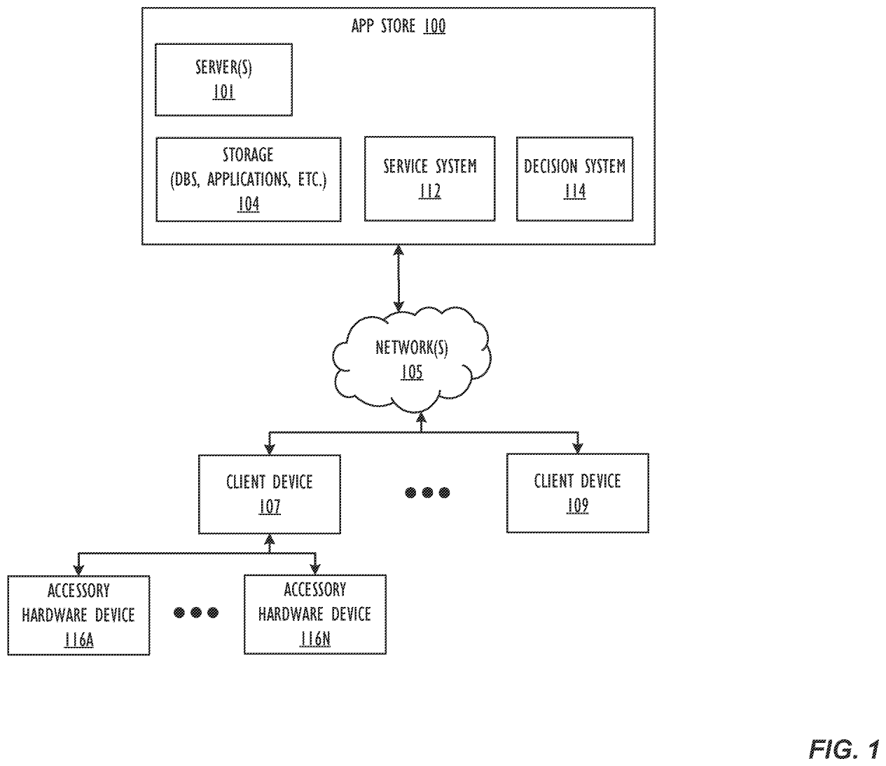

FIG. 1 illustrates, in block diagram form, a network by which an app store is accessed by client devices, according to one or more embodiments. The network diagram includes a digital distribution platform (referred to herein as an app store) 100, communicably connected to client devices 107 and 109 across one or more network(s) 105. Network(s) 105 may include, for example, the Internet, a wide area network, a local area network, or the like, or any combination thereof.

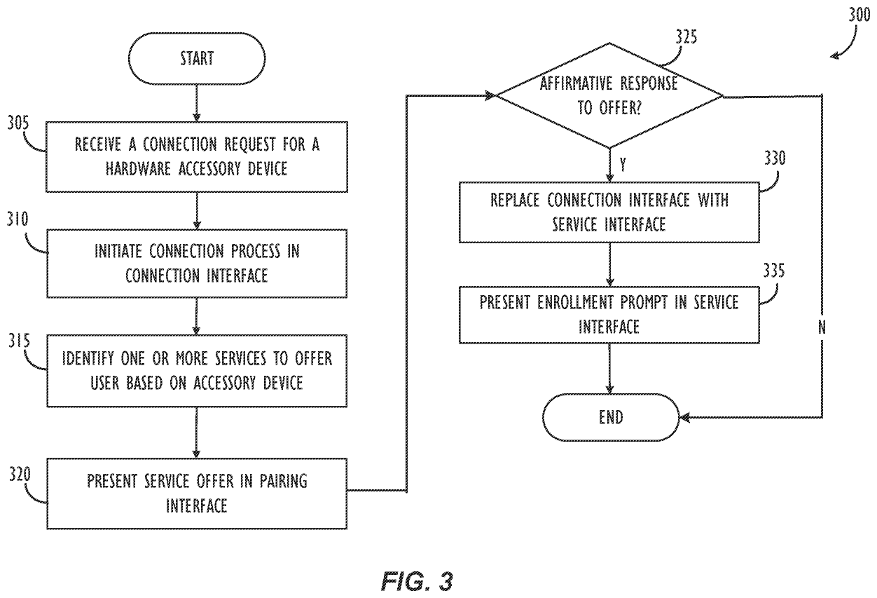

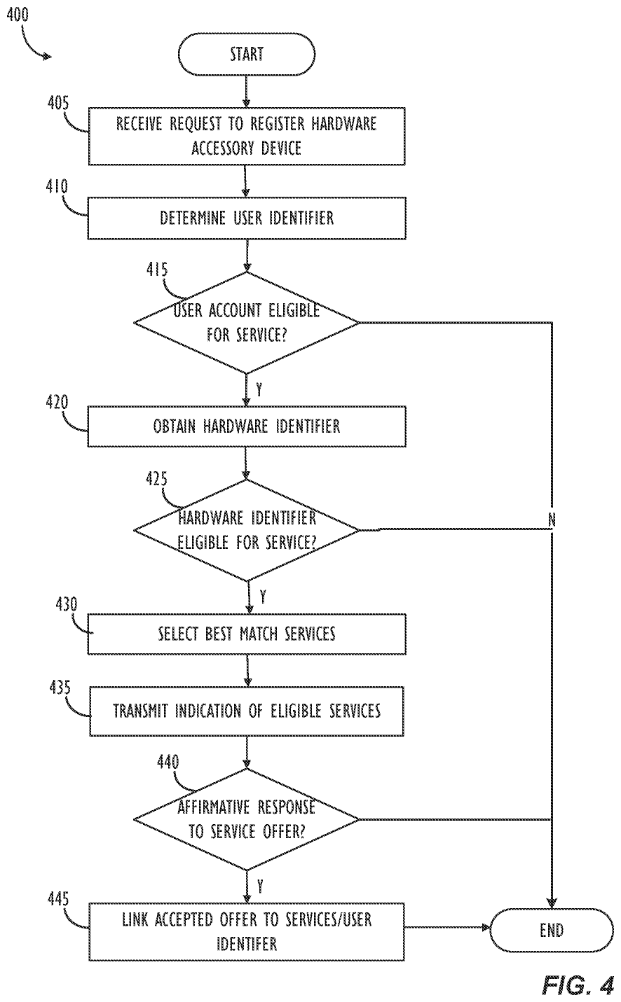

The embodiments described herein can operate within and interface with the environment and context of an app store from which one or more users, using client devices, can search for and download one or more applications (also referred to as apps) which can provide enhancement services to client devices, such as client device 107 and 109. An app store 100 can include one or more servers, such as server(s) 101 that can provide the functionality described herein. For example, server(s) 101 can interface with a client device and/or other devices to implement the methods of FIGS. 3 and 4 to provide access to resources, for example to client devices 107 and 109 which can take a variety of different forms (e.g., tablet computer such as an iPad, smartphone such as an iPhone, laptop computer, desktop computer, network media player such as an Apple TV, game/entertainment system, or other consumer electronic device). The client devices 107 and 109 can be coupled to the app store 100 by one or more networks 105, which provide for the data communication between the client devices and the app store so that the client devices can register devices, access resources, and the like.

According to one or more embodiments, the app store 100 may additionally include a service system 112 and a decision system 114. In one or more embodiments, the service system 112 is configured to manage access offers to various enhancement services, for example digital services hosted by the app store 100. In some embodiments, the service system 112 may track eligibility metrics and parameters for users, devices, enhancement services, and the like to identify, based on a connection event, available access offers. For example, the available access offers can be identified in accordance with a registration event for the hardware device. As an example, during a connection event, the accessory hardware device can be paired or otherwise connected to the client device. The connection event may involve a handshake with one or more back-end servers, through which the hardware accessory device may be registered.

The app store 100 may additionally include a decision system 114. In some embodiments, the decision system may obtain available enhancement service offers from the service system 112 and select, from the available offers, one or more particular offers for presentation during a connection event involving a hardware device. In some embodiments, the decision system 114 may select at least one enhancement service offer from the identified enhancement service offers to provide to the client device. The decision system may select the at least one enhancement service offer based on one or more predetermined selection criterion. For example, in some embodiments, the selection criterion may be configured to determine a best enhancement service offer based on the hardware accessory device, the client device, a user profile, contextual information, or some combination thereof.

Client devices, such as client devices 107 and 109 can connect to accessory devices, such as accessory hardware device 116A and accessory hardware device 116N. Accessory hardware devices 116A-N may include electronic devices communicably couplable to a client device. Examples of accessory hardware devices include, but are not limited to, headphones or other audio devices, keyboards, game/entertainment systems, digital streaming devices, exercise equipment, wearable electronic devices, and the like. Moreover, in some embodiments, the accessory hardware device may be part of a larger system, and/or may be connected via a wired connection, such as a vehicle enabled with interactive functionality with a mobile device.

The server(s) 101 and/or the client devices 107 and 109 and various systems can also include memory for storing, managing, and/or retrieving resources from the app store 100 including data related to enhancement service offers for the resources. According to some embodiments, the client devices 107 and 109 may provide access to the app store 100, on which multiple applications may be hosted. Memory may include one or more different types of media used by a processor of the device, in order to perform device functions. For example, memory may include memory cache, read-only memory (ROM), and/or random access memory (RAM). Storage 104 may store media (e.g., audio, image and video files), computer program instructions or software, preference information, device profile information, and any other suitable data. Storage 104 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory and storage may be used to retain computer program instructions or code organized into one or more modules and written in any desired computer programming language. When executed by, for example, processor, such computer program code may implement one or more of the methods described herein.

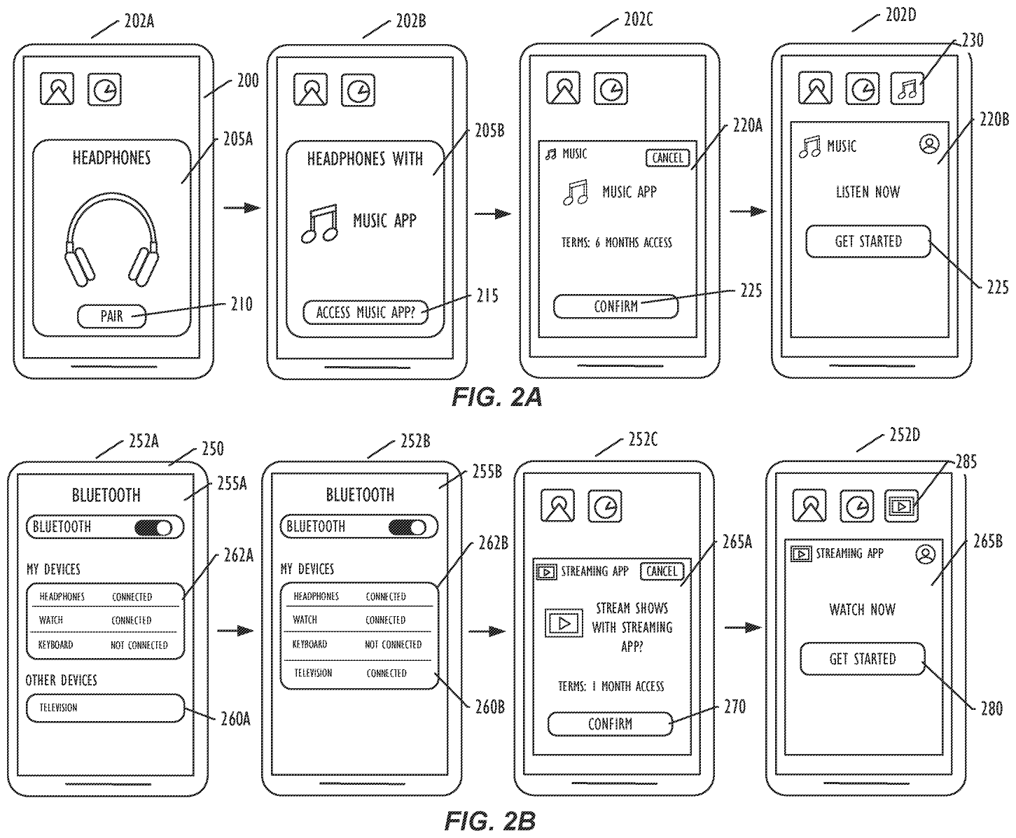

FIG. 2A depicts a flow of interfaces of a technique for providing an enhancement service offer in association with a hardware connection event. The flow includes an electronic device 200 which is connecting to headphones. It should be understood that headphones are used as an example hardware accessory device in this figure, but the hardware accessory device described herein is not limited to headphones. At 202A, the electronic device 200 presents a connecting interface 205A, by which a user can select a user-selectable component 210 to pair the headphones to the electronic device 200.

Moving on to step 202B, if a user selects the user-selectable component to pair the headphones to the electronic deice, then the connecting interface 205B prompts the user to initiate access to an enhancement service. In this example, the electronic device 200 prompts the user to initiate access to a music app service. Although the example of FIG. 2A utilizes a music app as the enhancement service to which access is offered, it should be understood that the enhancement service may be any digital services. Generally, an enhancement service includes a digital service that can enhance the experience of using the hardware for which the connection event causes the offer to be provided. As such, the enhancement services is not required to operate the accessory hardware device. Similarly, the enhancement service may be used independently of the accessory hardware device. Thus, when the hardware accessory device is initially connected to the electronic device, the offer prompt is presented in the connecting interface 205B for initiating access to the digital enhancement service by the electronic device 200 such that a user has the optional ability to use the hardware accessory device with the enhancement service. As such, the connecting interface 205B may include a user selectable component 215 which, when selected, indicates an affirmative request to open an interface related to the enhancement service. The interface may include, for example, a service interface as described below, a landing page in an app store, or the like.

Turning to step 202C, if a user selects the user-selectable component to initiate access to the enhancement service, then the electronic device 200 transitions to presenting an enrollment interface 220A for the enhancement service. The enrollment interface 220A may include information regarding the terms of the access. In one or more embodiments, the enrollment interface may be associated with the enhancement service and may not be related to the connecting interface 205. The connecting interface may include a user input component 225 which, when selected, indicates an affirmative request to initiate access to the enhancement service. If selected, then the flow concludes at 202D, where the electronic device 200 initiates access to the enhancement service. This may include, for example, linking the enhancement service to a user profile, downloading an application for the enhancement service as depicted by enhancement service icon 230, or the like. In some embodiments, the enrollment interface 265 may include one or more user input components 225 by which a user can navigate through an enrollment interface to begin using the enhancement service.

Turning to FIG. 2B another example is presented of a flow of interfaces of a technique for providing an enhancement service offer in association with a hardware connection event. The flow beings at 252A and includes an electronic device 250 which is attempting to connect to a new device in connection interface 255A. Here, the connection interface 255A includes a Bluetooth menu and a list of known devices 262A, and other, unknown devices 260A. Here, the unknown devices include a Bluetooth-enabled television that has been detected. It should be understood that while a television is used as an example hardware accessory device in this figure, the hardware accessory device described herein is not limited to any particular type of hardware accessory device. Moving on to step 252B, if a user selects the user-selectable component to connect the Bluetooth-enabled television to the electronic device, then the electronic device 250 performs the necessary handshake and indicates on the connecting interface 255B that the Bluetooth-enabled television is a known device.

According to some embodiments, the process of performing the necessary handshake and connecting to a new device causes the device to present, at 252C, an enrollment interface for an enhancement service. In this example, the electronic device 250 prompts the user to initiate access to a streaming service to stream digital content. Although the example of FIG. 2B utilizes a streaming app as the enhancement service to which access is offered, it should be understood that the enhancement service may be any digital services. Generally, an enhancement service includes a digital service that can enhance the experience of using the hardware for which the connection event causes the offer to be provided. As such, the enhancement services is not required to operate the accessory hardware device. Similarly, the enhancement service may be used independently of the accessory hardware device. Thus, when the hardware accessory device is initially connected to the electronic device, the offer prompt 265A is presented for initiating access to the digital enhancement service by the electronic device 250 such that a user has the optional ability to use the hardware accessory device with the enhancement service (e.g., stream media from the app to the streaming service). Further, in some embodiments, once access is provided on the electronic device 250, the associated user account can be provided access on additional devices. As an example, the user of electronic device 252 may be provided access to the streaming app service directly from the television or other devices. For example, once downloaded on to the television or other devices, the user is connected to the service via the user account and does not have to re-enroll.

Turning to step 252D the electronic device 250 initiates access to the enhancement service. This may include, for example, linking the enhancement service to a user profile, downloading an application for the enhancement service as depicted by enhancement service icon 285, or the like. In some embodiments, the enrollment interface 265B may include one or more user input components 280 by which a user can navigate through an enrollment interface to begin using the enhancement service.

FIG. 3 illustrates, in flowchart form, a technique for providing a service offer during a hardware connection event, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 300 begins at block 305 where a connection request is received for a hardware accessory device. The connection request may be received by an electronic device to connect a new accessory hardware device that is previously unknown to the electronic device. In some embodiments, the connection request may include a request for the hardware accessory device to become interoperable with the electronic device, either through a wired or wireless connection. For example, an accessory hardware device can be discovered by the electronic device, and the connection request may include a pairing process. As another example, the electronic mobile device may connect to an in-vehicle information system and/or media player either through a wired or short-range wireless connection.

The flowchart 300 continues at block 310 where a connection process is initiated. In some embodiments, the connection process includes necessary handshakes or other data transmittals that enable interoperability between the electronic device and the accessory hardware device. Then, at block 315, one or more enhancement services are identified which may be offered to the user. At the user device, the device may simply receive an offer from a remote system to present to a user. Additionally, or alternatively, the client device 107 may select an offer from among available or eligible enhancement services. The selection of service offers to present to the user will be described in greater detail below with respect to FIG. 4.

The flowchart 300 continues at block 320 where the service offer is presented. In some embodiments, the offer is presented in the connection interface. Alternatively, as shown in FIG. 2B, the service offer may be presented in an interface specific to the enhancement service which may be separately presented from a connection interface. At block 325, a determination is made as to whether an affirmative response is received. For example, a user may select an input component on the user interface which indicates acceptance of the service offer. If an affirmative response is not received, then the flowchart 300 ends.

Returning to block 325, if an affirmative response is received, then the flowchart 300 continues to block 330. At block 320, the connection interface is replaced with the service interface. As described above, in some embodiments, the offer may be presented in a separate interface from the connection interface and, as such, this step may be skipped. The service interface may be associated with the enhancement service. In some embodiments, the service interface may be an interface that is part of the enhancement service, or may be part of a distribution service, such as a landing page for the enhancement service in an app store.

The flowchart concludes at block 335 where an enrollment prompt is presented in the service interface. In some embodiments, the enrollment prompt may include one or more user input components by which a user can navigate through an enrollment interface to begin using the enhancement service.

FIG. 4 illustrates, in flowchart form, a technique for determining available service offers for a client device, in accordance with one or more embodiments. Although the various actions are depicted in a particular order, in some embodiments the various actions may be performed in a different order. In still other embodiments, two or more of the actions may occur simultaneously. According to yet other embodiments, some of the actions may not be required or other actions may be included. For purposes of clarity, the flowchart will be described with respect to the various components of FIG. 1. However, it should be understood that the various actions may be taken by alternative components, according to one or more embodiments.

The flowchart 400 begins at block 405, where a device receives a request to register the hardware accessory device. In one or more embodiments, a service system 112 receives the request in response to a user initiating a connection request between the hardware accessory device and a client electronic device. During the connection request, the client electronic device may transmit a request to register the hardware accessory device 116 with the service system 112. At block 410, a user identifier is determined. The user identifier may be included in the request received at block 405, or otherwise determinable from the request.

At block 415, a determination is made regarding whether the user account is eligible for one or more enhancement services. In some embodiments, the service system 112 may determine whether the user account is eligible for any enhancement services based on a data structure including available offers. In some embodiments, the service system 112 may determine whether offers have already been accepted (and therefore, are no longer available to the user account), if the user already has access to the enhancement service, or the like. For example, in some embodiments, if the user already has access to the enhancement service, then the service system 112 may determine that the user account is no longer eligible for the service offer. If the user account is not eligible for any enhancement services, then the flowchart 400 concludes.

Returning to block 415, if the user account is eligible for an enhancement service, then the flowchart 400 continues to block 420. At block 420, the service system 112 obtains a hardware identifier for the accessory hardware device being registered during a connection request. In one or more embodiments, the client electronic device may transmit the hardware identifier along with the request to register the hardware accessory device 116 with the service system 112 as described above with respect to block 405. The hardware identifier may include a unique identifier for the accessory hardware device, such as a serial number, or may be a more general identifier, such as a device type or classification (i.e., audio devices, video devices, activity devices, gaming devices, etc.) At block 410, a user identifier is determined. The user identifier may be included in the request received at block 405, or otherwise determinable from the request.

The flowchart 400 continues at block 425, a determination is made regarding whether the hardware identifier is eligible for any enhancement service offers. Eligibility may be based on one or more predetermined rules or criteria for linking enhancement service offers to accessory hardware devices. In some embodiments, the determination may be made based on a classification of the hardware accessory device (i.e., media devices, exercise devices, display devices, etc.). Additionally, or alternatively, eligibility may be determined based on a source of the accessory hardware device, or other characteristics of the hardware accessory device. Further, in one or more embodiments, a determination may be made regarding whether the hardware identifier is eligible for any enhancement services from the enhancement services identified above with respect to block 415. If the hardware identifier is not eligible for any enhancement services, then the flowchart 400 concludes.

Returning to block 425, if the hardware accessory device is eligible for an enhancement service, then the flowchart 400 continues to block 430. At block 430, a determination is made regarding one or more best matches among the eligible enhancement services. This may include the eligible enhancement services for which the user account and/or hardware accessory device is eligible. The best matches may be determined, for example, by a decision system 114 that is separate from the service system 112, according to one or more embodiments. In some embodiments, one or more eligible enhancement services are compared to one or more best match criteria to select one or more best match enhancement service to present to the user. Then, at block 435, an indication of the best match enhancement services is transmitted to the user. In some embodiment, the indication may cause the electronic device to present an enhancement service offer to the user, as described above with respect to FIG. 3. If, at block 440, an affirmative response is not received, then the flowchart 400 ends. Otherwise, if, at block 440, an affirmative response is received to the enhancement service offer, then the flowchart 400 concludes at block 445 and the accepted enhancement offer is linked to the user identifier, for example by the service system 112.

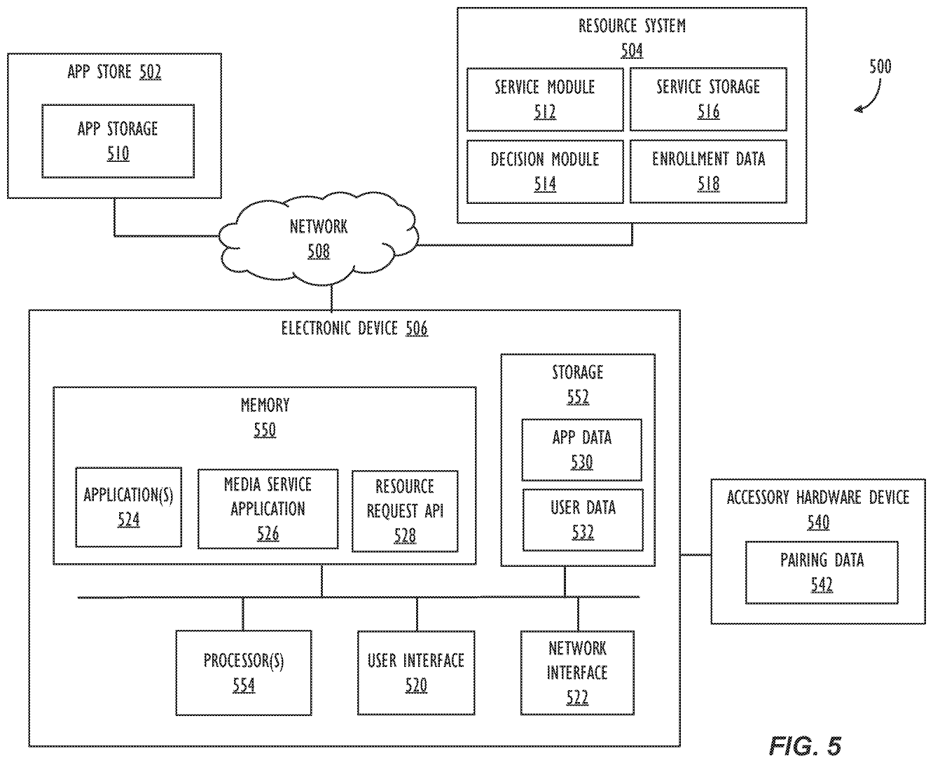

FIG. 5 illustrates an example network diagram for providing access to resources in association with a hardware connection event, in accordance with one or more embodiments. In particular, FIG. 5 depicts an alternative example network diagram in which a resource system 504 is configured to determine eligibility and manage access to enhanced services which may be hosted remotely, such as in app store 502.

The network diagram 500 includes a digital distribution platform (referred to herein as an app store) 502, communicably connected to an electronic device 506, as well as resource system 504 across one or more network(s) 105. Network(s) 105 may include, for example, the Internet, a wide area network, a local area network, or the like, or any combination thereof.

An app store 502 can include one or more network devices on which app data can be stored, such as app storage 510. In some embodiments, app store 502 can interface with a client device and/or other devices to provide enhancement services once access is provided. Electronic device 506 can take a variety of different forms (e.g., tablet computer such as an iPad, smartphone such as an iPhone, laptop computer, desktop computer, network media player such as an Apple TV, game/entertainment system, or other consumer electronic device). The electronic device 506 can be coupled to the app store 502 by one or more networks 105, which provide for the data communication between the client devices and the app store so that the client devices can register devices, access resources, and the like.

According to one or more embodiments, electronic device 506 may be a consumer device configured to run one or more programming modules, such as applications 524, as well as other executable components, such as media service application 526, and resource request API 528, for example. Media service application 524 is an example of an enhancement service which the electronic device 506 is provided access to in accordance with a connection event between the electronic device 506 and the accessory hardware device 540. Resource request API 528 may include a programming module by which a connection request is linked to an enhancement service offer, as described herein. The programming modules are processed by one or more processor(s) 554 from a memory 550. Processor(s) 554 may include one or more different kinds of processors, such as a central processing unit (CPU), graphical processing unit (GPU), and the like. In some embodiments, processor(s) 554 may be a system-on-chip. Memory 550 may include memory cache, read-only memory (ROM), and/or random-access memory (RAM).

Storage 552 may store suitable data for executing the programming modules, such as app data 530 and other data such as user data 532. The app data 530 may include data required for operation of the components executable from memory 550, such as application(s) 524, media service application 526, and resource request API 528. Storage 552 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Electronic device 506 may include a user interface 520 through which a user can interact with the programmable modules, such as application(s) 524. The user interface 520 can include input components, display components, audio components, and the like. Electronic device 506 also includes a network interface 522, over which the electronic device connects to other devices across network 508.

Embodiments herein describe a connection event between the electronic device 506 and a hardware accessory device 540. Accessory hardware devices 540 may include electronic devices communicably couplable to a client device. Examples of accessory hardware devices include, but are not limited to, headphones or other audio devices, keyboards, game/entertainment systems, digital streaming devices, exercise equipment, wearable electronic devices, and the like. Moreover, in some embodiments, the accessory hardware device may be part of a larger system, and/or may be connected via a wired connection, such as a vehicle enabled with interactive functionality with a mobile device. In some embodies, accessory hardware device 540 may include pairing data 542 or other connection data for initiating a connection with the electronic device 506. In some embodiments, the pairing data 542 may include a hardware identifier or other information from which the accessory hardware device 540 may be classified and/or from which eligible enhancement services can be identified.

Electronic device 506 may be communicably coupled to a resource system 504 across the network 508. Resource system 504 may be comprised of one or more network and/or computing devices, such as servers, network storage, remote computing devices, and the like. Further, in some embodiments, the functionality of the various components described within the resource system 504 may be hosted on a single device or may be distributed across multiple devices.

According to one or more embodiments, the resource system 504 may include a service module 512 and a decision module 516. In one or more embodiments, the service module 512 is configured to manage access offers to various enhancement services, for example digital services hosted by the app store 502. In some embodiments, the service system 512 may track eligibility metrics and parameters for users, devices, enhancement services, and the like to identify, based on a connection event, available access offers. For example, the available access offers can be identified in accordance with a registration event for the hardware device. As an example, during a connection event, the accessory hardware device can be paired or otherwise connected to the client device. The connection event may involve a handshake with one or more back-end servers, through which the hardware accessory device may be registered.

The resource system 504 may additionally include a decision module 514. In some embodiments, the decision module 514 may obtain available enhancement service offers from the service module 512 and select, from the available offers, one or more particular offers for presentation during a connection event involving a hardware device. In some embodiments, the decision system 114 may select at least one enhancement service offer from the identified enhancement service offers to provide to the client device. The decision system may select the at least one enhancement service offer based on one or more predetermined selection criterion. For example, in some embodiments, the selection criterion may be configured to determine a best enhancement service offer based on the hardware accessory device, the client device, a user profile, contextual information, or some combination thereof. In some embodiments, resource system 504 may include other components, such as service storage 516 and enrollment data 518. In some embodiments, service storage 516 may include data from which potential enhancement services are identified. For example, service storage may include a data structure within which an indication of available enhancement service offers and/or eligibility terms are stored. Enrollment data 518 may include a data structure including linkages between a user account of the electronic device 506 and accepted enhancement service offers.

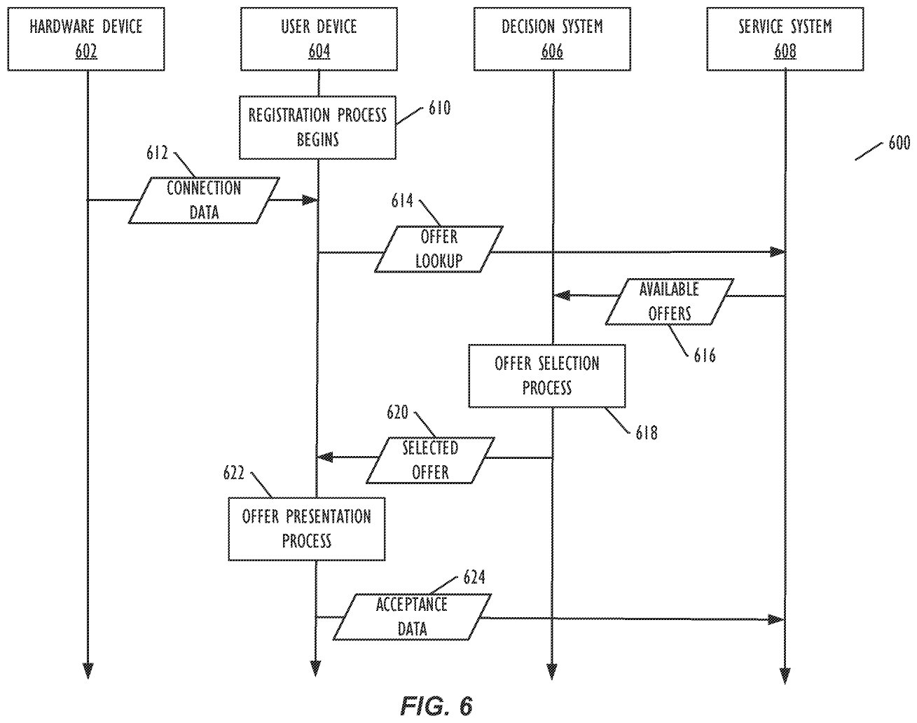

FIG. 6 illustrates an example flow diagram for selecting and providing offers to access to resources, in accordance with one or more embodiment. In some embodiments, it may be beneficial for the decision system to perform separately from the service system. For example, for privacy or security reasons, the decision system may select one or more best offers from among candidate enhancement service offers determined by the service system without the decision system having access to the rules or parameters by which the service system selects candidate enhancement service offers. On the other hand, the service system may maintain potential service enhancement offers without having insight into how the decision system determines one or more best match enhancement services to serve up to a user device.

The flow diagram 600 shows data flow across an accessory hardware device 602, a user device 604, a decision system 606 and a service system 608. The flow diagram begins with an initiation of a registration process 610. In some embodiments, the registration process may be part of a connection event in which the user device 604 initiates a connection with an accessory hardware device 602. As part of the registration process, the accessory hardware device 602 may provide connection data to enable the connection. In some embodiments, the connection data 612 may include an identifier for the hardware accessory device 602, or other information for which a category or type of hardware accessory device 602 can be identified.

The flow diagram 600 continues with the user device 604 sending an offer lookup to the service system 608. The offer lookup 614 may be an explicit request for available enhancement service offers. Additionally, or alternatively, the offer lookup 614 may be other data which triggers the service system 608 to determine whether any enhancement service offers are available. For example, the offer lookup 614 may be part of a handshake technique by which the user device 604 registers the accessory hardware device 602.

As described above with respect to FIG. 4, the service system 608 may determine available offers 616 based on user account characteristics, accessory hardware device information, and/or the like. The available offers 616 are then provided to decision system 606. Then, the decision system 606 can determine one or more beset match offers to serve up to the user device, for example based on one or more best match criteria through an offer selection process 618. The best match criteria may be based on user characteristics, enhancement service characteristics, hardware device characteristics, characteristics of the available enhancement service offers, or the like. Further, in some embodiments, the best match criteria may include user preference information.

Once the decision system 606 selects one or more offers in the offer selection process 618, then the selected offer 620 can be transmitted or otherwise provided to the user device 604. Then, at block 622, the user device may present the enhancement service offer for a user. The enhancement service offer may provide a user with an opportunity to accept the offer, for example through a user interface component. If the enhancement service offer is acceptance, then acceptance data 624 is transmitted to the service system 608, so that the service system 608 modifies a data structure linking the user account to available and/or accepted offers, and the like.

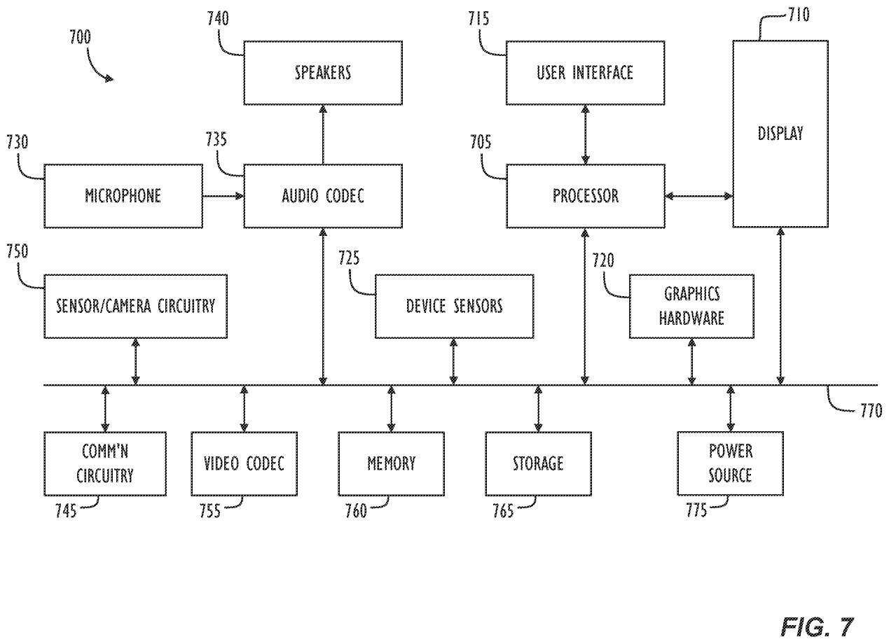

Referring now to FIG. 7, a simplified functional block diagram of an illustrative programmable electronic device 700 for providing access to an app store is shown, according to one embodiment. Electronic device 700 could be, for example, a mobile telephone, personal media device, portable camera, or a tablet, notebook or desktop computer system, network device, wearable device, or the like. As shown, electronic device 700 may include processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, image capture circuit or unit 750, which may, e.g., comprise multiple camera units/optical sensors having different characteristics (as well as camera units that are housed outside of, but in electronic communication with, device 700), video codec(s) 755, memory 760, storage 765, and communications bus 770.

Processor 705 may execute instructions necessary to carry out or control the operation of many functions performed by device 700 (e.g., such as the generation and/or processing of app store metrics accordance with the various embodiments described herein). Processor 705 may, for instance, drive display 710 and receive user input from user interface 715. User interface 715 can take a variety of forms, such as a button, keypad, dial, a click wheel, keyboard, display screen and/or a touch screen. User interface 715 could, for example, be the conduit through which a user may view a captured video stream and/or indicate particular images(s) that the user would like to capture or share (e.g., by clicking on a physical or virtual button at the moment the desired image is being displayed on the device's display screen).

In one embodiment, display 710 may display a video stream as it is captured while processor 705 and/or graphics hardware 720 and/or image capture circuitry contemporaneously store the video stream (or individual image frames from the video stream) in memory 760 and/or storage 765. Processor 705 may be a system-on-chip such as those found in mobile devices and include one or more dedicated graphics processing units (GPUs). Processor 705 may be based on reduced instruction-set computer (RISC) or complex instruction-set computer (CISC) architectures or any other suitable architecture and may include one or more processing cores. Graphics hardware 720 may be special purpose computational hardware for processing graphics and/or assisting processor 705 perform computational tasks. In one embodiment, graphics hardware 720 may include one or more programmable graphics processing units (GPUs).

Image capture circuitry 750 may comprise one or more camera units configured to capture images, e.g., in accordance with this disclosure. Output from image capture circuitry 750 may be processed, at least in part, by video codec(s) 755 and/or processor 705 and/or graphics hardware 720, and/or a dedicated image processing unit incorporated within circuitry 750. Images so captured may be stored in memory 760 and/or storage 765. Memory 760 may include one or more different types of media used by processor 705, graphics hardware 720, and image capture circuitry 750 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 760 and storage 765 may be used to retain computer program instructions or code organized into one or more modules and written in any desired computer programming language. When executed by, for example, processor 705, such computer program code may implement one or more of the methods described herein. Power source 775 may comprise a rechargeable battery (e.g., a lithium-ion battery, or the like) or other electrical connection to a power supply, e.g., to a mains power source, that is used to manage and/or provide electrical power to the electronic components and associated circuitry of electronic device 700.

In the foregoing description, numerous specific details are set forth, such as specific configurations, properties, and processes, etc., in order to provide a thorough understanding of the embodiments. In other instances, well-known processes and manufacturing techniques have not been described in particular detail in order to not unnecessarily obscure the embodiments. Reference throughout this specification to “one embodiment,” “an embodiment,” “another embodiment,” “other embodiments,” “some embodiments,” and their variations means that a particular feature, structure, configuration, or characteristic described in connection with the embodiment is included in at least one embodiment. Thus, the appearances of the phrase “for one embodiment,” “for an embodiment,” “for another embodiment,” “in other embodiments,” “in some embodiments,” or their variations in various places throughout this specification are not necessarily referring to the same embodiment. Furthermore, the particular features, structures, configurations, or characteristics may be combined in any suitable manner in one or more embodiments.

In the following description and claims, the terms “coupled” and “connected,” along with their derivatives, may be used. It should be understood that these terms are not intended as synonyms for each other. “Coupled” is used herein to indicate that two or more elements or components, which may or may not be in direct physical or electrical contact with each other, co-operate or interact with each other. “Connected” is used to indicate the establishment of communication between two or more elements or components that are coupled with each other.

Some portions of the preceding detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing system, that manipulates and transforms data represented as physical (electronic) quantities within the computer system's registers and memories into other data similarly represented as physical quantities within the computer system memories or registers or other such information storage, transmission or display devices.

Embodiments described herein can relate to an apparatus for performing a computer program (e.g., the operations described herein, etc.). Such a computer program may be stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

Although operations or methods are described above in terms of some sequential operations, it should be appreciated that some of the operations described may be performed in a different order. Moreover, some operations may be performed in parallel, rather than sequentially. Embodiments described herein are not described with reference to any particular programming language. It will be appreciated that a variety of programming languages may be used to implement the various embodiments of the disclosed subject matter. In utilizing the various aspects of the embodiments described herein, it would become apparent to one skilled in the art that combinations, modifications, or variations of the above embodiments are possible for managing components of a processing system to increase the power and performance of at least one of those components. Thus, it will be evident that various modifications may be made thereto without departing from the broader spirit and scope of at least one of the disclosed concepts set forth in the following claims. The specification and drawings are, accordingly, to be regarded in an illustrative sense, rather than a restrictive sense.

In the development of any actual implementation of one or more of the disclosed concepts (e.g., such as a software and/or hardware development project, etc.), numerous decisions must be made to achieve the developers' specific goals (e.g., compliance with system-related constraints and/or business-related constraints). These goals may vary from one implementation to another, and this variation could affect the actual implementation of one or more of the disclosed concepts set forth in the embodiments described herein. Such development efforts might be complex and time-consuming, but may still be a routine undertaking for a person having ordinary skill in the art in the design and/or implementation of one or more of the inventive concepts set forth in the embodiments described herein.

As described above, one aspect of the present technology is the gathering and use of data available from various sources to improve the delivery of enhancement digital services in association with a hardware connection event. The present disclosure contemplates that in some instances, this gathered data may include personal information data that uniquely identifies or can be used to contact or locate a specific person. Such personal information data can include demographic data, location-based data, telephone numbers, email addresses, social networking handles, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to determine certain app store metrics. Accordingly, use of such personal information data enables users to have more streamlined and meaningful experience with the app store and apps hosted by the app store. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of enhancement services, the present technology can be configured to allow users to select to “opt in” or “opt out” of participation in the collection of personal information data during registration for services or anytime thereafter. In another example, users can select not to provide their content and other personal information data for improved content sharing suggestion services. In yet another example, users can select to limit the length of time their personal information data is maintained by a third party, limit the length of time into the past from which content sharing suggestions may be drawn, and/or entirely prohibit the development of a knowledge graph or other metadata profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be suggested for sharing to users by inferring preferences based on non-personal information data or a bare minimum amount of personal information, such as the quality level of the content (e.g., focus, exposure levels, etc.) or the fact that certain content is being requested by a device associated with a contact of the user, other non-personal information available to the app store, or publicly available information.

As used in the description above and the claims below, the phrases “at least one of A, B, or C” and “one or more of A, B, or C” include A alone, B alone, C alone, a combination of A and B, a combination of B and C, a combination of A and C, and a combination of A, B, and C. That is, the phrases “at least one of A, B, or C” and “one or more of A, B, or C” means A, B, C, or any combination thereof, such that one or more of a group of elements consisting of A, B and C, and should not be interpreted as requiring at least one of each of the listed elements A, B and C, regardless of whether A, B and C are related as categories or otherwise. Furthermore, the use of the article “a” or “the” in introducing an element should not be interpreted as being exclusive of a plurality of elements. Also, the recitation of “A, B, and/or C” is equal to “at least one of A, B, or C.” Also, the use of “a” refers to “one or more” in the present disclosure. For example, “an application” refers to “one application” or “a group of applications.”

What is claimed is:

1. A non-transitory computer readable medium comprising computer readable code executable by one or more processors to:
receive, at a local device, a connection request to connect a hardware accessory with the local device;
identify, in response to the connection request, one or more services for the local device based on the hardware accessory; and
present a prompt on a user interface to initiate access by the local device to the service.

2. The non-transitory computer readable medium of claim 1, wherein the connection request comprises a hardware accessory identifier, and wherein the computer readable code to identify the one or more services comprises computer readable code to:
provide the hardware accessory identifier to a service system, wherein the service system identifies one or more eligible services based on the hardware accessory identifier.

3. The non-transitory computer readable medium of claim 2, wherein the service system further identifies one or more eligible services based on a user account associated with the connection request.

4. The non-transitory computer readable medium of claim 3, wherein the computer readable code to identify, in response to the connection request, one or more services for the local device based on the hardware accessory further comprises computer readable code to:
select at least one service from the one or more services based on a best match criterion.

5. The non-transitory computer readable medium of claim 1, wherein the connection request is associated with a connecting interface for the hardware accessory, and wherein the prompt is presented in the connecting interface.

6. The non-transitory computer readable medium of claim 5, further comprising computer readable code to:
upon receiving an affirmative response to the prompt, cause an enrollment interface for the service to be presented on the local device.

7. The non-transitory computer readable medium of claim 6, further comprising computer readable code to transmit an indication to a service system that the access to the service has been initiated.

8. The non-transitory computer readable medium of claim 1, wherein the computer readable code to identify, in response to the connection request, one or more services for the local device based on the hardware accessory further comprises computer readable code to confirm that the local device does not currently have access to the service.

9. A method comprising:
receiving, at a local device, a connection request to connect a hardware accessory device with the local device;
identifying, in response to the connection request, one or more services for the local device based on the hardware accessory; and
presenting a prompt on a user interface to initiate access by the local device to the service.

10. The method of claim 9, wherein the connection request comprises a hardware accessory identifier, and wherein identifying the one or more services comprises:
providing the hardware accessory identifier to a service system, wherein the service system identifies one or more eligible services based on the hardware accessory identifier.

11. The method of claim 10, wherein the service system further identifies the one or more eligible services based on a user account associated with the connection request.

12. The method of claim 11, wherein identifying, in response to the connection request, one or more services for the local device based on the hardware accessory further comprises:
selecting at least one service from the one or more services based on a best match criterion.

13. The method of claim 9, wherein the connection request is associated with a connecting interface for the hardware accessory, and wherein the prompt is presented in the connecting interface.

14. The method of claim 13, further comprising:
upon receiving an affirmative response to the prompt, causing an enrollment interface for a service to be presented on the local device.

15. The method of claim 14, further comprising transmitting an indication to a service system that the access to the service has been initiated.

16. The method of claim 9, wherein identifying, in response to the connection request, one or more services for the local device based on the hardware accessory further comprises computer readable code to confirm that the local device does not currently have access to the service.

17. A system comprising:
one or more processors; and
one or more computer readable media comprising computer readable code executable by the one or more processors to:
receive, at a local device, a connection request to connect a hardware accessory device with the local device;
identify, in response to the connection request, one or more services for the local device based on the hardware accessory; and
present a prompt on a user interface to initiate access by the local device to the service.

18. The system of claim 17, wherein the connection request comprises a hardware accessory identifier, and wherein the computer readable code to identify the one or more services comprises computer readable code to:
provide the hardware accessory identifier to a service system, wherein the service system identifies one or more eligible services based on the hardware accessory identifier.

19. The system of claim 18, wherein the service system further identifies one or more eligible services based on a user account associated with the connection request.

20. The system of claim 19, wherein the computer readable code to identify, in response to the connection request, one or more services for the local device based on the hardware accessory further comprises computer readable code to:
select at least one service from the one or more services based on a best match criterion.
